(19) United States
(12) Patent Application Publication
(10) Pub. No.: US 2023/0131546 A1
(43) Pub. Date: Apr. 27, 2023

(54) CLAMP AND WIRE HARNESS

(71) Applicant: SUMITOMO WIRING SYSTEMS, LTD., Yokkaichi-shi (JP)

(72) Inventors: Ryuta SAITO, Yokkaichi-shi (JP); Katsutoshi IZAWA, Yokkaichi-shi (JP); Kosuke TANAKA, Yokkaichi-shi (JP)

(73) Assignee: SUMITOMO WIRING SYSTEMS, LTD., Yokkaichi-shi (JP)

(21) Appl. No.: 17/959,922

(22) Filed: Oct. 4, 2022

(30) Foreign Application Priority Data
Oct. 22, 2021 (JP) 2021-173225

(51) Int. Cl. H02G 3/32; F16L 3/10; F16B 2/22; B60R 16/02

(52) U.S. Cl. CPC H02G 3/32; B60R 16/0215; F16B 2/22; F16L 3/1075

(57) ABSTRACT

A clamp including: a holding implement that holds an outer tube the outer tube being cylindrical and surrounding an outer circumference of a wire; and a fixing implement that is linked to the holding implement and is fixed to a fixing target part, wherein: the holding implement is a separate component from the fixing implement, the holding implement includes a holding part that holds the outer tube, and a first linking part, and the fixing implement includes a fixing part fixed to the fixing target part, and a second linking part linked to the first linking part.

### BACKGROUND

The present disclosure relates to a clamp and a wire harness.

A wire harness including a clamp which holds an outer member enclosing a wire member and which is fixed to a vehicle body is known (see, for example, JP 2018-101462A). This type of clamp includes a holding part that holds the outer member and a fixing part that is fixed to the vehicle body.

### SUMMARY

Incidentally, there is demand for clamps such as those described above to be more versatile, and there is room for further improvement in this respect.

An exemplary aspect of the disclosure provides a clamp and a wire harness capable of improving versatility.

A clamp according to the present disclosure includes: a holding implement that holds an outer tube the outer tube being cylindrical and surrounding an outer circumference of a wire; and a fixing implement that is linked to the holding implement and is fixed to a fixing target part, wherein: the holding implement is a separate component from the fixing implement, the holding implement includes a holding part that holds the outer tube, and a first linking part, and the fixing implement includes a fixing part fixed to the fixing target part, and a second linking part linked to the first linking part.

A wire harness according to the present disclosure includes: a wire; an outer tube that is cylindrical and that surrounds an outer circumference of the wire; and a clamp attached to an outer circumference of the outer tube, wherein: the clamp includes: a holding implement that holds the outer tube; and a fixing implement that is linked to the holding implement and is fixed to a fixing target part, the holding implement is a separate component from the fixing implement, the holding implement includes a holding part that holds the outer tube, and a first linking part, and the fixing implement includes a fixing part fixed to the fixing target part, and a second linking part linked to the first linking part.

The clamp and the wire harness of the present disclosure have an effect of improving versatility.

### BRIEF DESCRIPTION OF THE DRAWINGS

FIG. 1 is a diagram illustrating the overall configuration of a wire harness according to an embodiment.

FIG. 2 is a general side view of a wire harness according to an embodiment.

FIG. 3 is a general exploded perspective view of a wire harness according to an embodiment.

FIG. 4 is a general horizontal cross-sectional view of a wire harness according to an embodiment.

FIG. 5 is a general cross-sectional view of a wire harness according to an embodiment.

FIG. 6 is a general exploded perspective view of part of a clamp according to an embodiment.

FIG. 7 is a general horizontal cross-sectional view of a wire harness according to a variation.

FIG. 8 is a general exploded perspective view of part of a clamp according to a variation.

FIG. 9 is a general exploded perspective view of part of a clamp according to a variation.

### DETAILED DESCRIPTION OF EMBODIMENTS

First, embodiments of the present disclosure will be described as examples.
(1) A clamp according to the present disclosure includes: a holding implement that holds an outer member, the outer member being cylindrical and surrounding an outer circumference of a wire member; and a fixing implement that is linked to the holding implement and is fixed to a fixing target part. The holding implement is a separate component from the fixing implement; the holding implement includes a holding part that holds the outer member, and a first linking part; and the fixing implement includes a fixing part fixed to the fixing target part, and a second linking part linked to the first linking part.
   According to this configuration, the holding implement and the fixing implement are formed as separate components, and the holding implement and the fixing implement are linked by linking the first linking part of the holding implement with the second linking part of the fixing implement. The single clamp is configured by linking the holding implement and the fixing implement. Accordingly, even if the structure of the fixing part is changed to match the shape of the fixing target part, as long as the fixing implement includes the second linking part, the fixing implement can be linked to the holding implement including the first linking part. In other words, one type of holding implement can be used in common for a plurality of types of fixing implements. Similarly, even if the structure of the holding part is changed to match the shape of the outer member, as long as the holding implement includes the first linking part, the holding implement can be linked to the fixing implement including the second linking part. In other words, one type of fixing implement can be used in common for a plurality of types of holding implements. This makes it possible to improve the versatility of the clamp.
(2) A wire harness according to the present disclosure includes: a wire member; an outer member that is cylindrical and that surrounds an outer circumference of the wire member; and a clamp attached to an outer circumference of the outer member. The clamp includes: a holding implement that holds the outer member; and a fixing implement that is linked to the holding implement and is fixed to a fixing target part. The holding implement is a separate component from the fixing implement; the holding implement includes a holding part that holds the outer member, and a first linking part; and the fixing implement includes a fixing part fixed to the fixing target part, and a second linking part linked to the first linking part.
   According to this configuration, the holding implement and the fixing implement are formed as separate components, and the holding implement and the fixing implement are linked by linking the first linking part of the holding implement with the second linking part of the fixing implement. The single clamp is configured by linking the holding implement and the fixing implement. Accordingly, even if the structure of the fixing part is changed to match the shape of the fixing target part, as long as the fixing implement includes the second linking part, the fixing implement can be linked to the holding implement including the first linking part. In other words, one type of holding implement can be used in common for a plurality of types of fixing implements. Similarly, even if the structure of the holding part is changed to match the shape of the outer member, as long as the holding implement includes the first linking part, the holding implement can be linked to the fixing implement including the second linking part. In other words, one type of fixing implement can be used in common for a plurality of types of holding implements.
(3) Preferably, the wire harness further includes a path restricting member that is attached to the outer circumference of the outer member and that restricts a path along which the wire member is routed; the path restricting member includes a first main body part that covers part of the outer circumference of the outer member, and an insertion opening that is open in a direction orthogonal to a length direction of the first main body part and that extends over an entire length of the first main body part in the length direction thereof; and the holding part holds the outer member and the path restricting member. According to this configuration, the outer member and the path restricting member are held by the holding part of the holding implement. Additionally, the fixing implement linked to the holding implement is fixed to the fixing target part. Accordingly, by fixing the fixing implement to the fixing target part, the outer member and the path restricting member can be fixed to the fixing target part.
(4) Preferably, the holding part is formed in an annular shape that surrounds an outer circumference of the path restricting member, and the outer circumference of a part of the outer member to which the path restricting member is attached, over an entire circumferential direction; and the holding part includes a second main body part, and a lid part linked to the second main body part. According to this configuration, the clamp including the holding part can be retrofitted to the path restricting member and the outer member by having the holding part divided into the second main body part and the lid part, even with the holding part having an annular shape. This improves the ease of assembly of the wire harness.
(5) Preferably, the path restricting member includes a first engagement part; and the holding part includes a second engagement part that engages with the first engagement part in a circumferential direction of the path restricting member. According to this configuration, the first engagement part provided in the path restricting member and the second engagement part provided in the holding part engage with each other, which suppresses relative movement of the path restricting member with respect to the holding part in the circumferential direction of the path restricting member. In other words, a situation where the path restricting member rotates in the circumferential direction relative to the holding part can be suppressed by the first engagement part and the second engagement part engaging with each other. Accordingly, misalignment of the path restricting member with respect to the holding part in the circumferential direction of the path restricting member can be suppressed, and the positional accuracy of the path restricting member with respect to the holding part can be improved.
(6) Preferably, the path restricting member includes a first end and a second end which are respective ends of the path restricting member in the circumferential direction and which form the insertion opening; the second engagement part includes a projecting part that protrudes toward the insertion opening from an inner surface of the holding part; and the projecting part is capable of contacting at least one of the first end and the second end in the circumferential direction of the path restricting member. According to this configuration, the projecting part of the holding part can contact at least one of the first end and the second end that form the insertion opening in the circumferential direction of the path restricting member. Accordingly, the projecting part is engaged with the first end or the second end in the circumferential direction of the path restricting member. This makes it possible to favorably suppress a situation in which the path restricting member rotates in the circumferential direction relative to the holding part.
(7) Preferably, the outer member is a corrugated tube having an accordion structure in which an annular convex part and an annular concave part are provided alternately in series along a length direction of the outer member; and the projecting part includes a protrusion that enters into the annular concave part. According to this configuration, the projecting part includes a protrusion that enters into the annular concave part of the corrugated tube. Accordingly, movement of the corrugated tube relative to the clamp in the length direction of the corrugated tube can be suppressed.
(8) Preferably, the first engagement part includes a recess provided in an outer surface of the first main body part; and the second engagement part includes a convex part that protrudes toward the path restricting member from the inner surface of the holding part and that mates with the recess. According to this configuration, the recess provided in the outer surface of the first main body part and the convex part provided on the inner surface of the holding part mate together, such that the recess and the convex part are engaged with each other in the circumferential direction of the path restricting member. This makes it possible to suppress relative movement of the path restricting member with respect to the holding part in the circumferential direction of the path restricting member.
(9) Preferably, the path restricting member includes: a first end and a second end which are respective ends of the path restricting member in the circumferential direction and which form the insertion opening; a first protrusion that protrudes from an inner surface of at least one of the first end or the second end, and which is capable of contacting the outer surface of the outer member; and a second protrusion that protrudes from an inner surface of a part of the first main body part where the recess is provided, and which is capable of contacting the outer surface of the outer member. According to this configuration, the path restricting member includes the first protrusion that protrudes from an inner surface of at least one of the first end or the second end, and which is capable of contacting the outer surface of the outer member. The outer member can be pressed from the outside of the outer member, for example, by the first protrusion. A situation where the path restricting member withdraws from the outer member through the insertion opening can therefore be favorably suppressed. Additionally, the path restricting member includes the second protrusion, which protrudes from the inner surface of the first main body part and is capable of contacting the outer surface of the outer member. Accordingly, both the first protrusion and the second protrusion can be brought into contact with the outer surface of the outer member. This makes it possible to suppress situations where the path restricting member rattles against the outer member.

### Details of Embodiment of Present Disclosure

Specific examples of a wire harness of the present disclosure will be described hereinafter with reference to the drawings. In each drawing, some parts of the configuration may be exaggerated or simplified to simplify the descriptions. The dimensional proportions of each part may differ from drawing to drawing as well. In the present specification, “orthogonal”, “perpendicular”, and “entire length” include not only cases where the item in question is strictly orthogonal, perpendicular, or the entire length, but also cases where the item is generally orthogonal, perpendicular, or the entire length, to the extent that the actions and effects of the embodiment can be achieved. Additionally, the term “cylindrical” as used in the present specification includes not only items having a continuous circumferential wall formed around the entire circumferential direction, but also items having a plurality of parts combined to form a cylindrical shape, items having a notch or the like in part of the circumferential direction, such as a C-shape, and the like. Note that “cylindrical” shapes include, but are not limited to, circular, oval, and polygonal shapes having sharp or rounded corners. Furthermore, the term “annular” as used in the present specification may refer to any structure that forms a loop, or a continuous shape without ends, as well as a generally loop-shaped structure having a gap, such as a C-shape. Note that “annular” shapes include, but are not limited to, circular, oval, and polygonal shapes having sharp or rounded corners. Furthermore, the term “opposing” as used in the present specification refers to surfaces or members positioned in front of each other with respect to each other, and includes cases where the items are in perfectly forward-facing positions with respect to each other as well as where the items are in partially forward-facing positions with respect to each other. Additionally, the term “opposing” as used in the present specification includes both cases where a member different from two parts is interposed between the two parts as well as cases where nothing is interposed between the two parts. Note that the present disclosure is not intended to be limited to these examples, and is defined instead by the scope of the claims, and all modifications equivalent in meaning and scope thereof are intended to be included therein.

### Overall Configuration of Wire Harness 10

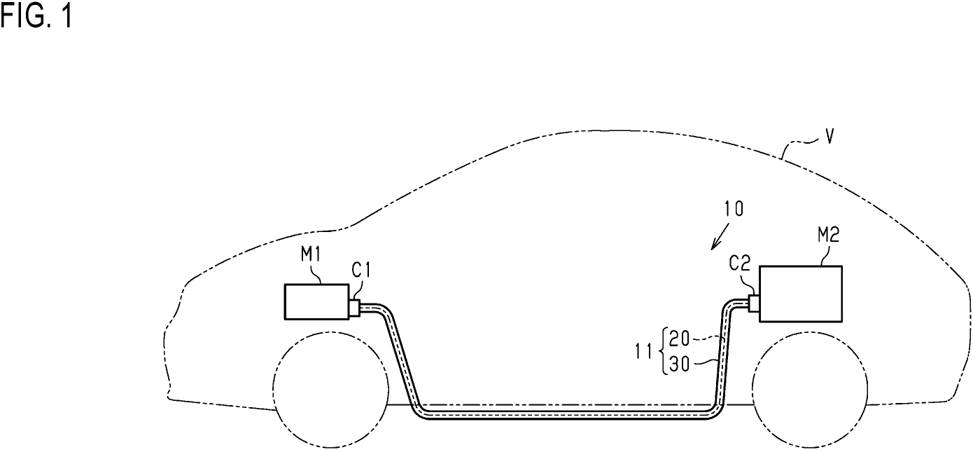

A wire harness 10 illustrated in FIG. 1 is installed in a vehicle V, such as a hybrid vehicle, an electric automobile, or the like, for example. The wire harness 10 electrically connects two or more vehicle-mounted devices to each other. A vehicle-mounted device is an electrical device installed in the vehicle V. The wire harness 10 electrically connects, for example, an inverter M1 installed in a front part of the vehicle V and a high-voltage battery M2 installed further toward the rear of the vehicle V than the inverter M1. The wire harness 10 is formed, for example, having a long shape extending in a front-back direction of the vehicle V. The wire harness 10 is routed through the vehicle V such that, for example, a middle part in the length direction of the wire harness 10 passes outside the vehicle cabin, such as under the floor of the vehicle V.

The inverter M1 is connected, for example, to a wheel driving motor (not shown), which serves as a power source for vehicle travel. The inverter M1 generates AC power from DC power of the high-voltage battery M2 and supplies that AC power to the motor. The high-voltage battery M2 is, for example, a battery capable of supplying a voltage of several hundred volts.

The wire harness 10 includes a wire harness main body 11. The wire harness main body 11 of the wire harness includes a wire member 20 (wire) and a cylindrical outer member 30 (outer tube) that surrounds the outer circumference of the wire member 20. The wire harness 10 includes connectors C1 and C2 attached to respective ends of the wire member 20. One end of the wire member 20 in the length direction is connected to the inverter M1 via the connector C1, and the other end of the wire member 20 in the length direction is connected to the high-voltage battery M2 via the connector C2.

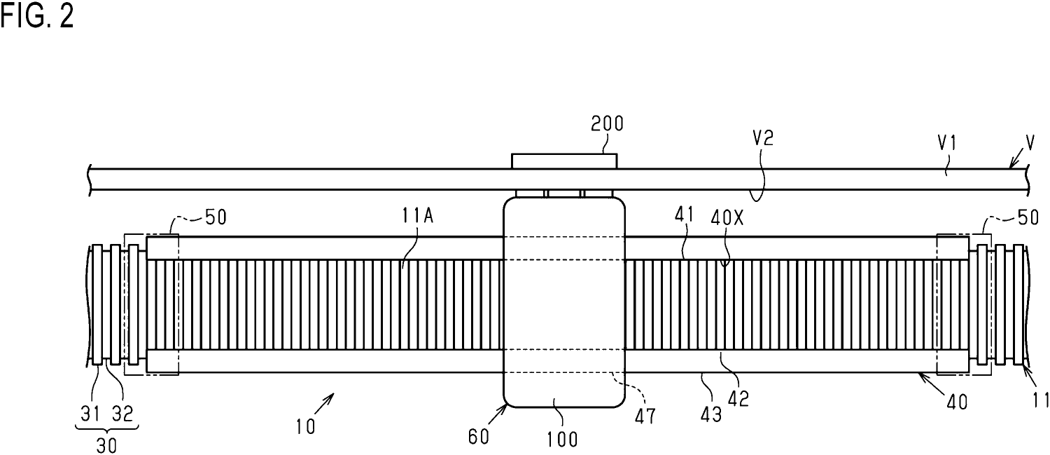

As illustrated in FIG. 2, the wire harness 10 includes a path restricting member 40 (path restricting cover) that is attached to the outer circumference of the outer member 30 and that restricts the path along which the wire member 20 is routed, and a restricting member 50 that restricts movement of the path restricting member 40 relative to the outer member 30. The wire harness 10 includes a clamp 60 that holds the outer member 30 and is fixed to a vehicle body V1 of the vehicle V. Note that the path restricting member 40, the restricting member 50, and the clamp 60 are not shown in FIG. 1.

### Configuration of Wire Member 20

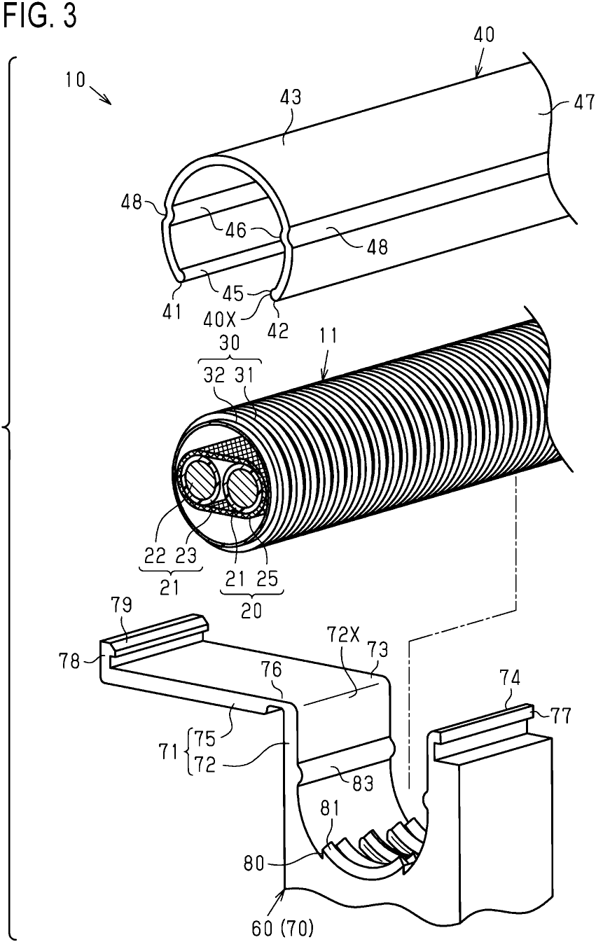

As illustrated in FIG. 3, the wire member 20 includes, for example, one or more wires 21 (two, in the present embodiment) and a braided member 25 that surrounds the outer circumferences of the plurality of wires 21 together.

Each of the wires 21 is a coated wire having a conductive core wire 22 and an insulative coating 23 that surrounds the outer circumference of the core wire 22 and is insulative. Each of the wires 21 is, for example, a high-voltage wire capable of handling high voltages and high currents. Each of the wires 21 may be, for example, a non-shielded wire that has no electromagnetic shielding structure of its own, or a shielded wire that has an electromagnetic shielding structure of its own. Each of the wires 21 in the present embodiment is a non-shielded wire.

For example, a stranded wire constituted by a plurality of metal strands twisted together or a single-core wire constituted by a single conductive body can be used as the core wire 22. A column-shaped conductive body constituted by a single metal rod having a columnar shape with a solid inner structure, a cylindrical conductive body with a hollow inner structure, or the like can be used as the single-core wire, for example. A combination of stranded wires, column-shaped, or cylindrical conductive bodies may be used as the core wire 22. The material of the core wire 22 can be, for example, a metal material such as a copper-based or aluminum-based material.

The insulative coating 23 covers the outer circumferential surface of the core wire 22 in the entire circumferential direction, for example. The insulative coating 23 is constituted by an insulative resin material, for example.

The cross-sectional shape of each of the wires 21 when cut along a plane orthogonal to the length direction of the wire 21, i.e., the lateral cross-sectional shape of each of the wires 21, can be any shape. The lateral cross-sectional shape of each of the wires 21 is, for example, circular, semi-circular, polygonal, square, flat, or the like. The lateral cross-sectional shape of each of the wires 21 in the present embodiment is circular.

The braided member 25 has, for example, a cylindrical shape that surrounds the outer circumferences of the plurality of wires 21 together. The braided member 25 can be, for example, a braided wire constituted by a plurality of metal strands, or a braided wire constituted by a combination of metal strands and resin strands. The material of the metal strands can be, for example, a metal material such as a copper-based or aluminum-based material. Although not illustrated, both ends of the braided member 25 in the length direction are grounded at, for example, the connectors C1 and C2 (see FIG. 1).

### Configuration of Outer Member 30

The outer member 30 has a cylindrical shape that surrounds the outer circumference of the wire member 20 in the entire circumferential direction. The outer member 30 in the present embodiment is formed in a cylindrical shape. The outer member 30 is sealed, for example, in the entire circumferential direction of the outer member 30. The outer member 30 has, for example, a function of protecting the wire member 20 from flying objects, water droplets, and the like.

The outer member 30 is flexible and easily bendable, for example. A corrugated tube made of resin, a rubber waterproof cover, and the like can be given as examples of the flexible outer member 30. The outer member 30 of the present embodiment is a corrugated tube made of resin and having an accordion structure having annular convex parts 31 and annular concave parts 32 which are provided alternately in series along the length direction of the outer member 30. Each of the annular convex parts 31 and annular concave parts 32, for example, is annular, making a single revolution along the circumferential direction of the outer member 30. For example, a synthetic resin such as polyolefin, polyamide, polyester, ABS resin, or the like can be used as the material of the outer member 30.

### Configuration of Path Restricting Member 40

As illustrated in FIG. 2, the path restricting member 40 holds the outer member 30. The path restricting member 40 is stiffer than the outer member 30, for example. Compared to the outer member 30, the path restricting member 40 has a hardness that makes it more difficult to bend in a direction orthogonal to the length direction of the wire harness main body 11. For example, the path restricting member 40 assists the outer member 30 in preventing the wire harness main body 11 from bending under its own weight or the like and deviating from a desired path. For example, the outer member 30 is more difficult to bend than it would be without the path restricting member 40 attached. The path restricting member 40 is partially provided in the length direction of the wire harness main body 11. One or more path restricting members 40 are provided, in accordance with the path of the wire harness main body 11.

The path restricting member 40 is attached to the outer circumference of the outer member 30 at a straight part 11A, which is a part of the path of the wire harness main body 11 that is straight, for example. The path restricting member 40 restricts the path of the wire harness main body 11 in the straight part 11A. Here, the straight part 11A is a part where the path of the wire harness main body 11 extends in a straight line in one direction.

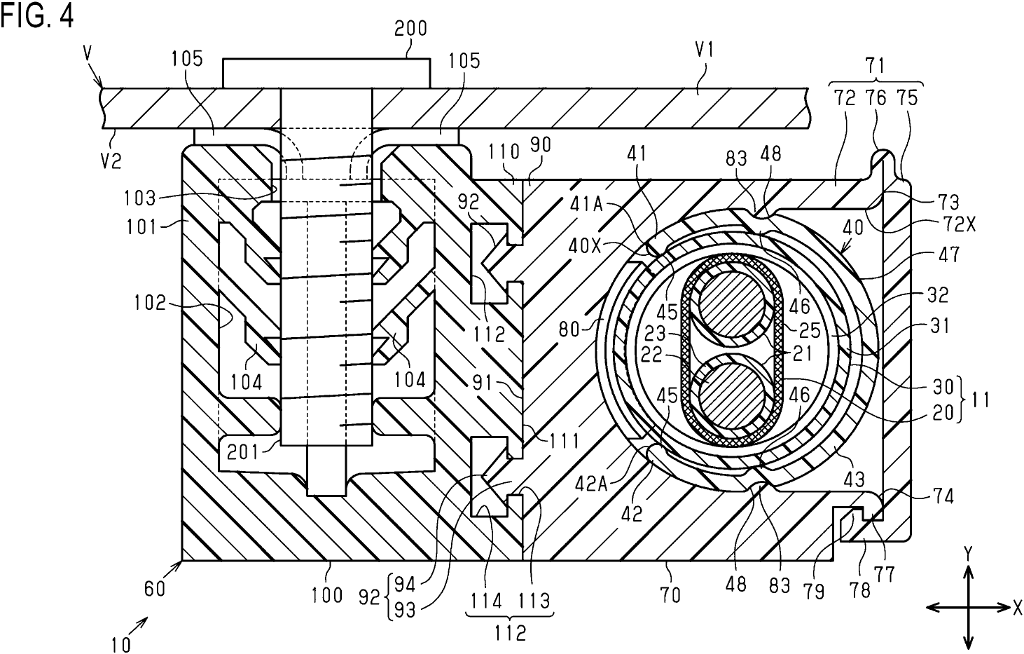

As illustrated in FIG. 4, the path restricting member 40 covers a part of the outer circumference of the outer member 30 in the circumferential direction of the outer member 30. The path restricting member 40 has a cylindrical shape that covers the outer circumference of the outer member 30 in part of the circumferential direction of the outer member 30. The path restricting member 40 covers a range larger than half of the outer circumference of the outer member 30, for example. The lateral cross-sectional shape of the path restricting member 40 is a C-shape as a whole. The lateral cross-sectional shape of the path restricting member 40 is uniform over the entire length of the path restricting member 40 in the length direction, for example. As illustrated in FIG. 2, the path restricting member 40 extends along the path of the straight part 11A, and is formed in a shape which extends in a straight line in one direction, for example.

The path restricting member 40 is made of a metal or a resin, for example. The path restricting member 40 of the present embodiment is made of a resin. For example, a synthetic resin such as polypropylene, polyamide, polyacetal, or the like can be used as the material of the path restricting member 40. The path restricting member 40 can be manufactured through extrusion molding, injection molding, or the like, for example.

The path restricting member 40 has an insertion opening 40X that opens in a direction orthogonal to the length direction of the path restricting member 40. The path restricting member 40 has a first end 41 and a second end 42, which correspond to respective ends of the path restricting member 40 in the circumferential direction and which form the insertion opening 40X. The path restricting member 40 has a first main body part 43 (first main body) that links the first end 41 and the second end 42. In other words, the path restricting member 40 has the first main body part 43 covering part of the outer member 30 in the circumferential direction, the first end 41 and the second end 42 provided at respective ends of the first main body part 43 in the circumferential direction, and the insertion opening 40X formed by the first end part 41 and the second end part 42.

As illustrated in FIG. 4, the first main body part 43 constitutes the main part of the path restricting member 40. A thickness of the first main body part 43 in a radial direction is, for example, uniform in the circumferential direction of the path restricting member 40. The lateral cross-sectional shape of the first main body part 43 is formed as a shape that follows an outer surface of the outer member 30, for example. The lateral cross-sectional shapes of the first end 41, the second end 42, and the first main body part 43 are arc shapes, for example.

The first end 41 and the second end 42 are provided on opposite sides from each other in the circumferential direction of the first main body part 43. The first end 41 and the second end 42 are provided separated from each other in the circumferential direction of the first main body part 43, with the insertion opening 40X located therebetween. In other words, a gap between the first end 41 and the second end 42 in the circumferential direction of the path restricting member 40 is configured as the insertion opening 40X. In this manner, the path restricting member 40 is formed in a C-shape having the insertion opening 40X in a part of the circumferential direction of the first main body part 43.

The first end 41 has a tip 41A. The second end 42 has a tip 42A. The tips 41A and 42A form the insertion opening 40X. The tips 41A and 42A are formed in a curved shape when viewed from the length direction of the path restricting member 40. In other words, the lateral cross-sectional shapes of the tips 41A and 42A are curved shapes. The lateral cross-sectional shapes of the tips 41A and 42A in the present embodiment are semicircular.

The path restricting member 40 includes, for example, a first protrusion 45 protruding from the inner surface of each of the first end 41 and the second end 42. Each first protrusion 45 protrudes toward the outer member 30 inserted inside the path restricting member 40, and can contact the outer surface of the outer member 30. Each first protrusion 45 is in contact with the outer surface of the annular convex part 31 of the outer member 30, for example. Two first protrusions 45, for example, protrude from the respective inner surfaces of the tips 41A and 42A. The lateral cross-sectional shape of each first protrusion 45 is, for example, a curved shape. The lateral cross-sectional shape of each first protrusion 45 in the present embodiment is semicircular. Each first protrusion 45 extends in the length direction of the path restricting member 40. Each first protrusion 45 extends over the entire length of the path restricting member 40 in the length direction, for example.

The path restricting member 40 includes, for example, one or more (two, in the present embodiment) second protrusions 46 protruding from the inner surface of the first main body part 43. Each second protrusion 46 protrudes toward the outer member 30 from the inner surface of the first main body part 43, and can contact the outer surface of the outer member 30. Each second protrusion 46 is in contact with the outer surface of the annular convex part 31 of the outer member 30, for example. The two second protrusions 46 are provided with a gap therebetween with respect to the circumferential direction of the path restricting member 40. The lateral cross-sectional shape of each second protrusion 46 is a curved shape. The lateral cross-sectional shape of each second protrusion 46 in the present embodiment is semicircular, for example. Each second protrusion 46 extends over the entire length of the path restricting member 40 in the length direction, along the length direction of the path restricting member 40, for example.

Each first protrusion 45 and each second protrusion 46 presses on the outer member 30 from the outside of the outer member 30, for example. The outer member 30 is elastically sandwiched between each first protrusion 45 and each second protrusion 46, for example. This strengthens the linkage of the path restricting member 40 to the outer member 30. Therefore, a situation where the path restricting member 40 attached to the outer circumference of the outer member 30 moves in the length direction of the outer member 30 is suppressed.

Because each first protrusion 45 and each second protrusion 46 contact the outer surface of the outer member 30, a gap is produced between the inner surface of the first main body part 43 and the outer surface of the outer member 30. This gap is produced over the entire length of the path restricting member 40 in the length direction.

The opening width of the insertion opening 40X, i.e., the shortest distance between the first end 41 and the second end 42, is smaller than the outer diameter of the outer member 30, for example. As illustrated in FIG. 3, the insertion opening 40X extends in the length direction of the first main body part 43. The insertion opening 40X extends in the length direction of the first main body part 43 over the entire length of the first main body part 43 in the length direction. In other words, the insertion opening 40X is formed to open in a direction orthogonal to the length direction of the first main body part 43, and to open at both ends of the first main body part 43 in the length direction.

By inserting the outer member 30 into the insertion opening 40X from a direction orthogonal to the length direction of the first main body part 43, the first main body part 43 elastically deforms, and the opening width of the insertion opening 40X increases. When the outer member 30 is inserted into the interior of the first main body part 43, the first main body part 43 elastically restitutes so as to return to its original shape. As a result, the opening width of the insertion opening 40X becomes smaller than the outer diameter of the outer member 30, and the path restricting member 40 is therefore attached to the outer circumference of the outer member 30.

As illustrated in FIG. 2, the path restricting member 40 includes a connection part 47 that is connected to the clamp 60. The connection part 47 is provided, for example, in the middle part of the path restricting member 40 in the length direction. The connection part 47 is provided, for example, in the center of the path restricting member 40 in the length direction.

As illustrated in FIG. 4, the connection part 47 includes one or more recesses 48 serving as first engagement parts (first engagements). The connection part 47 in the present embodiment includes two of the recesses 48. Each recess 48 is provided in the outer surface of the first main body part 43 at the connection part 47. Each recess 48 is provided, for example, in the outer surface of the part of the first main body part 43 where a corresponding second protrusion 46 is provided. Each recess 48 is provided, for example, at a position overlapping the corresponding second protrusion 46 in the radial direction of the path restricting member 40. Each recess 48 is formed to be recessed inwardly in the radial direction of the path restricting member 40 from the outer surface of the first main body part 43. Each recess 48 is a recess that does not penetrate the first main body part 43 in the radial direction. The lateral cross-sectional shape of each recess 48 is a curved shape. The lateral cross-sectional shape of each recess 48 in the present embodiment is semicircular. As illustrated in FIG. 3, each recess 48 extends in the length direction of the wire harness main body 11, for example. Each recess 48 extends over the entire length of the connection part 47 in the length direction, for example. Each recess 48 extends in the length direction of the first main body part 43 over the entire length of the first main body part 43 in the length direction, for example.

### Configuration of Restricting Member 50

As illustrated in FIG. 2, the restricting member 50 is provided, for example, at both ends of the path restricting member 40 in the length direction. For example, resin or metal bundling bands, caulking rings, adhesive tape, or the like can be used as the restricting member 50. The restricting member 50 in the present embodiment is adhesive tape.

Each restricting member 50 is formed, for example, so as to secure each of the ends of the path restricting member 40 in the length direction to the outer surface of the outer member 30. Each restricting member 50 is wrapped, for example, from the end of the path restricting member 40 in the length direction, across the outer member 30. This suppresses a situation where the path restricting member 40 moves relative to the outer member 30 in the length direction and the circumferential direction of the wire harness main body 11.

### Configuration of Clamp 60

As illustrated in FIG. 2, the clamp 60 holds the path restricting member 40 attached to the outer member 30, and is fixed to a mounting surface V2 of the vehicle body V1, for example. The mounting surface V2 of the present embodiment is a surface outside the vehicle cabin under the floor of the vehicle V and opposing the ground. The vehicle body V1 is provided with a stud bolt 200 at the location where the clamp 60 is provided, for example. The stud bolt 200 is welded to the vehicle body V1, for example. As illustrated in FIG. 4, the stud bolt 200 is provided so that, for example, a shaft part 201 of the stud bolt 200 protrudes from the mounting surface V2 toward the ground. As illustrated in FIG. 2, the clamp 60 is provided, for example, in the middle part of the path restricting member 40 in the length direction. In the present embodiment, one clamp 60 is provided in the length direction of the path restricting member 40.

As illustrated in FIG. 4, the clamp 60 includes a holding implement 70 that holds the outer member 30 and a fixing implement 100 that is fixed to the vehicle body V1. The holding implement 70 is a separate component from the fixing implement 100. The holding implement 70 is linked (fixed) to the fixing implement 100. The holding implement 70 and the fixing implement 100 may be separably linked or inseparably linked. The holding implement 70 surrounds and holds the outer member 30 and the path restricting member 40, for example. The holding implement 70 and the fixing implement 100 are provided side-by-side along an X axis, for example. The X axis is orthogonal to the length direction of the outer member 30, for example. In the following descriptions, the direction extending along the X axis may be referred to as the “X axis direction”. The direction extending along a Y axis, which is orthogonal to the X axis, may be referred to as the “Y axis direction”. The fixing implement 100 is attached, for example, to the vehicle body V1 along the direction in which the stud bolt 200 extends, which here is along the Y axis direction. Accordingly, the holding implement 70 and the fixing implement 100 of the present embodiment are provided side-by-side in a direction that intersects with the attachment direction of the fixing implement 100 to the vehicle body V1.

The clamp 60 is made of a metal or a resin, for example. The holding implement 70 and the fixing implement 100 of the present embodiment are made of resin. For example, a synthetic resin such as polypropylene, polyamide, polyacetal, or the like can be used as the material of the holding implement 70 and the fixing implement 100. The material of the holding implement 70 and the material of the fixing implement 100 may be the same material or different materials. The holding implement 70 and the fixing implement 100 can be manufactured, for example, through injection molding or the like.

The holding implement 70 includes a holding part 71 that holds the outer member 30 and a first linking part 90. The holding implement 70 is, for example, a single component with the holding part 71 and the first linking part 90 formed as one piece. The fixing implement 100 has a fixing part 101 that is fixed to the vehicle body V1 and a second linking part 110 that is linked to the first linking part 90. The fixing implement 100 is, for example, a single component with the fixing part 101 and the second linking part 110 formed as one piece.

The holding part 71, for example, surrounds the outer circumference of the connection part 47 of the path restricting member 40. The holding part 71 is, for example, formed in an annular shape that surrounds the outer circumference of the connection part 47 and the outer circumference of the outer member 30 at the part to which the connection part 47 is attached, across the entire circumferential direction.

The holding part 71 includes, for example, a second main body part 72 (second main body) and a lid part 75 (lid) linked to the second main body part 72. The second main body part 72 is formed integrally with the first linking part 90, for example. The lid part 75 is formed integrally with the second main body part 72, for example.

The second main body part 72 covers a part of the outer circumference of the outer member 30 in the circumferential direction of the outer member 30, for example. The second main body part 72 covers a part of the outer circumference of the path restricting member 40 in the circumferential direction of the path restricting member 40, for example. The second main body part 72 has a cylindrical shape that covers the outer circumference of the path restricting member 40 in part of the circumferential direction of the path restricting member 40. The second main body part 72 covers a range larger than half of the outer circumference of the path restricting member 40, for example. The lateral cross-sectional shape of the inner surface of the second main body part 72 is formed as a shape that corresponds to an outer surface of the path restricting member 40, for example. The lateral cross-sectional shape of the inner surface of the second main body part 72 is, for example, a curved shape. The lateral cross-sectional shape of the inner surface of the second main body part 72 is a U-shape as a whole.

The second main body part 72 includes a third end 73 and a fourth end 74, which are respective ends of the second main body part 72 in the circumferential direction. The second main body part 72 includes a containment opening 72X formed by the third end 73 and the fourth end 74. The containment opening 72X is an opening between the third end 73 and the fourth end 74. The containment opening 72X opens in a direction orthogonal to the length direction of the second main body part 72. The containment opening 72X opens in a direction away from the fixing implement 100 in the X axis direction in which the holding implement 70 and the fixing implement 100 are side-by-side, for example. The containment opening 72X extends along the length direction of the second main body part 72, over the entire length of the second main body part 72 in the length direction. The opening width of the containment opening 72X, i.e., the shortest distance between the third end 73 and the fourth end 74, is equal to the outer diameter of the path restricting member 40 or greater than the outer diameter of the path restricting member 40, for example. The outer member 30 and the path restricting member 40 are inserted into the containment opening 72X along a direction orthogonal to the length direction of the second main body part 72. The term “equal” as used in the present specification includes cases of exact equality, as well as cases where there are slight differences between the objects being compared due to the effects of dimensional tolerances and the like.

The lid part 75 covers a part of the outer circumference of the outer member 30 in the circumferential direction of the outer member 30, for example. The lid part 75 covers a part of the outer circumference of the path restricting member 40 in the circumferential direction of the path restricting member 40, for example. The lid part 75 covers a range smaller than half of the outer circumference of the path restricting member 40, for example. The lid part 75 is formed in the shape of a flat plate as a whole, for example.

The holding part 71 includes, for example, a hinge part 76 that connects the second main body part 72 to the lid part 75. The hinge part 76 connects one end of the second main body part 72 in the circumferential direction to one end of the lid part 75 in the circumferential direction. The second main body part 72 and the lid part 75 are integrally-formed components formed integrally via the hinge part 76, for example. Here, one end of the second main body part 72 in the circumferential direction is, for example, the third end 73, which, of the third end 73 and the fourth end 74, is provided closer to the mounting surface V2. The other end of the second main body part 72 in the circumferential direction (the fourth end 74, here) is provided with a first lock part 77. The other end of the lid part 75 in the circumferential direction is provided with a second lock part 78 that can engage with the first lock part 77. The second lock part 78 protrudes perpendicularly from the lid part 75 toward the second main body part 72, for example. A lock claw 79 that protrudes toward the second main body part 72 is provided at a tip of the second lock part 78. The first lock part 77 is formed so as to engage with the lock claw 79.

The second main body part 72 and the lid part 75 can be rotated relative to each other about the hinge part 76. The lid part 75 can rotate between an open position, illustrated in FIG. 3, and a closed position, illustrated in FIG. 4, with the hinge part 76 serving as an axis. As illustrated in FIG. 4, with the lid part 75 in the closed position, the lock claw 79 of the second lock part 78 engages with the first lock part 77. The lid part 75 is held in the closed position by the first lock part 77 and the lock claw 79 engaging with each other. In this manner, the second main body part 72 and the lid part 75 are linked to each other. When the second main body part 72 and the lid part 75 are in a linked state, the holding part 71 forms an annular shape that surrounds the outer circumferences of the outer member 30 and the connection part 47 together. In other words, by being rotated relative to the second main body part 72 and held in the closed position, the lid part 75 can surround and hold the path restricting member 40 and the wire harness main body 11 with the second main body part 72.

The holding part 71 includes, for example, a projecting part 80 (projection) serving as a second engagement part. The projecting part 80 protrudes toward the insertion opening 40X of the path restricting member 40 held inside the holding part 71. The projecting part 80 protrudes so as to be positioned inside the insertion opening 40X of the path restricting member 40. The projecting part 80 can contact the first end 41 and the second end 42 in the circumferential direction of the path restricting member 40.

The projecting part 80 is provided, for example, on the inner surface of the second main body part 72. The projecting part 80 protrudes from the inner surface, of the second main body part 72, that opposes the lid part 75, toward the containment opening 72X, for example. The projecting part 80 is provided on the inner surface of the second main body part 72 at a part closest to the first linking part 90 in the circumferential direction of the holding part 71. Therefore, with the projecting part 80 positioned inside the insertion opening 40X of the path restricting member 40, the insertion opening 40X faces the first linking part 90 and the fixing implement 100.

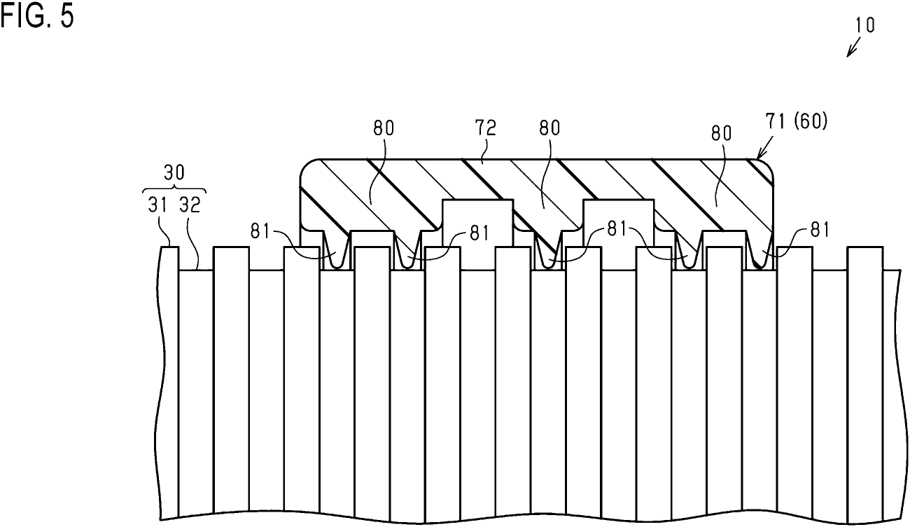

As illustrated in FIG. 5, the holding part 71 includes a plurality (three, in the present embodiment) of the projecting parts 80. The three projecting parts 80 are spaced from each other in the length direction of the outer member 30. Each projecting part 80 includes a protrusion 81 that enters the annular concave parts 32 of the outer member 30. The protrusion 81 protrudes further from the tip of the projecting part 80. A plurality of the protrusions 81 are provided in the length direction of the outer member 30. In the present embodiment, there are five protrusions 81 in the length direction of the outer member 30, each entering a different annular concave part 32.

As illustrated in FIG. 4, the holding part 71 includes one or more convex parts 83 serving as second engagement parts (second engagements), for example. The holding part 71 of the present embodiment includes two convex parts 83. Each convex part 83 is formed so as to be capable of engaging with a corresponding recess 48 in the circumferential direction of the path restricting member 40. The convex parts 83 are provided, for example, on the inner surface of the second main body part 72. Each convex part 83 is provided separated from the projecting part 80 in the circumferential direction of the holding part 71. Each convex part 83 protrudes, for example, from the inner surface of the second main body part 72 toward the first main body part 43 of the connection part 47. Each convex part 83 is formed to be capable of mating with a corresponding recess 48, for example. The lateral cross-sectional shape of each convex part 83 is, for example, a curved shape. The lateral cross-sectional shape of each convex part 83 is, for example, semicircular.

As illustrated in FIG. 3, each of the convex parts 83 extends along the length direction of the path restricting member 40, for example. Each convex part 83 is formed so as to be longer in the length direction of the path restricting member 40 than in the circumferential direction of the path restricting member 40. Each convex part 83 extends over the entire length of the holding part 71 in the length direction, for example.

As illustrated in FIG. 4, when the convex parts 83 are mated with the recesses 48, the recesses 48 and the convex parts 83 engage with each other in the circumferential direction of the path restricting member 40. Specifically, when the convex parts 83 mate with the recesses 48, the inner surfaces of the recesses 48 and the side surfaces of the convex parts 83 engage with each other in the circumferential direction of the path restricting member 40.

The first linking part 90 is provided opposite the second linking part 110 of the fixing implement 100. The first linking part 90 has a first opposing surface 91 that opposes the second linking part 110. The first linking part 90 includes, for example, one or more linking members 92 provided on the first opposing surface 91.

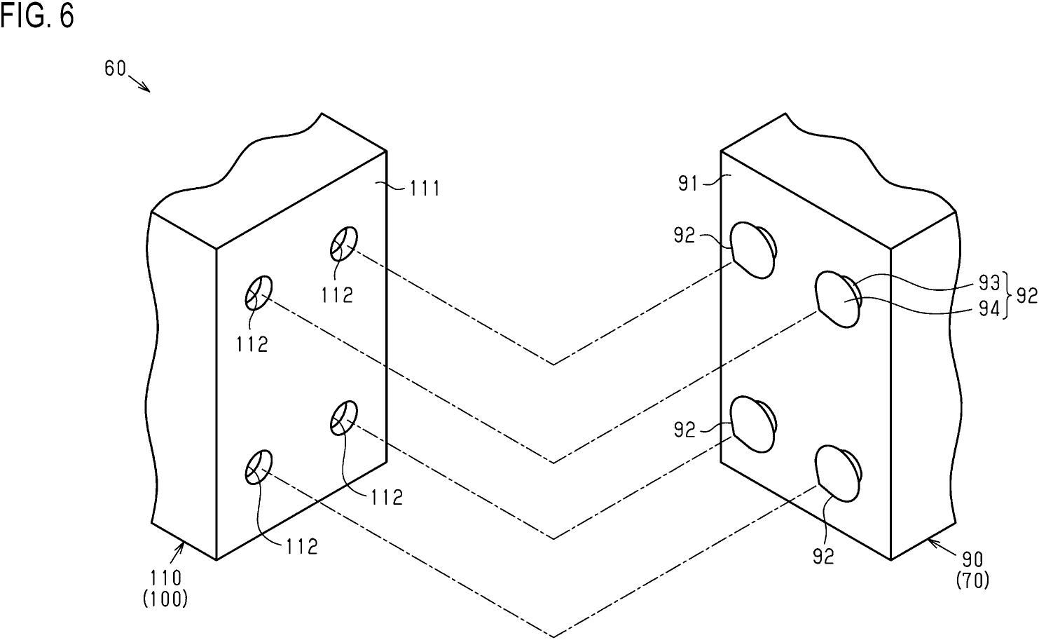

As illustrated in FIG. 6, the first linking part 90 of the present embodiment includes four of the linking members 92. The four linking members 92 are provided, for example, near each of the four corners of the first opposing surface 91.

As illustrated in FIG. 4, each linking member 92 includes, for example, a column part 93, and an engagement piece 94 provided at the tip of the column part 93. A base of the column part 93 is connected to the first opposing surface 91. The base of the column part 93 is formed so as to be continuous and integrated with the first opposing surface 91. The column part 93 extends along the X axis direction. The column part 93 is formed in the shape of a column extending from the first opposing surface 91 toward the fixing implement 100. The column part 93 of the present embodiment is formed in the shape of a cylinder.

The engagement piece 94 is formed so as to be continuous and integrated with the tip of the column part 93. The engagement piece 94 is formed so as to protrude outward from the tip of the column part 93. The engagement piece 94 is formed so as to protrude outward along the entire circumferential direction of the tip of the column part 93, for example. The engagement piece 94 is formed, for example, in the shape of a cone. The engagement piece 94 of the present embodiment is formed in the shape of a circular cone.

Here, the second linking part 110 of the fixing implement 100 is provided opposite the first linking part 90. The second linking part 110 has a second opposing surface 111 that opposes the first opposing surface 91 of the first linking part 90. The second linking part 110 includes one or more linking holes 112 provided on the second opposing surface 111. As illustrated in FIG. 6, the second linking part 110 of the present embodiment includes four of the linking holes 112. The four linking holes 112 are provided so as to oppose corresponding ones of the four linking members 92.

As illustrated in FIG. 4, each linking hole 112 includes, for example, a first opening 113 formed in the second opposing surface 111, and a second opening 114 that communicates with the first opening 113 and has a larger opening width than the first opening 113. The first opening 113 extends in the X axis direction. The first opening 113 is formed at a size that enables the column part 93 of the linking member 92 to be inserted. For example, the opening width of the first opening 113 in the Y axis direction is equal to the width of the column part 93 in the Y axis direction or slightly larger than the width of the column part 93 in the Y axis direction. Here, the first opening 113 in the present embodiment is formed having a cylindrical shape. The opening diameter of the first opening 113 is, for example, equal to the outer diameter of the column part 93 or slightly larger than the outer diameter of the column part 93. The opening width of the first opening 113 along the Y axis direction is smaller than the longest dimension of the engagement piece 94 in the Y axis direction. The dimension of the first opening 113 along the X axis direction is slightly smaller than the dimension of the column part 93 along the X axis direction. The second opening 114 is formed at a size that enables the engagement piece 94 to be accommodated inside. The opening width of the second opening 114 along the Y axis direction is, for example, larger than the longest dimension of the engagement piece 94 in the Y axis direction.

The engagement piece 94 of the linking member 92 is formed so as to be capable of being inserted into and engaging with the linking hole 112. For example, the engagement piece 94 is formed so as to be capable of elastically deforming, to be capable of being inserted into the first opening 113 and capable of engaging with the outer edge of the first opening 113 after being inserted into the first opening 113. The width of the widest part of the engagement piece 94 in a direction orthogonal to the X axis direction in which the column part 93 extends, which here is the diameter of the base surface of the circular cone, is set to be larger than the opening diameter of the first opening 113. The engagement piece 94 is formed to be capable of elastically deforming such that the diameter of the base surface of the circular cone is less than or equal to the opening diameter of the first opening 113.

As the engagement piece 94 is inserted into the first opening 113, the engagement piece 94 advances into the first opening 113 while elastically deforming so that the diameter of the base surface of the circular cone decreases. When the engagement piece 94 passes through the first opening 113, the engagement piece 94 elastically restitutes to return to its original shape, and the base surface of the engagement piece 94 is engaged with the outer edge of the first opening 113. As a result, the first linking part 90 is linked to the second linking part 110, and the holding implement 70 is linked to the fixing implement 100.

The fixing part 101 of the fixing implement 100 includes a bolt compartment 102 into which the shaft part 201 of the stud bolt 200 is inserted. An insertion hole 103 into which the shaft part 201 is inserted is formed in the surface of the fixing part 101 that opposes the mounting surface V2. The insertion hole 103 communicates with the bolt compartment 102. The bolt compartment 102 is provided with a plurality of engagement claws 104 that can elastically engage with threading grooves or circumferential grooves of the shaft part 201 of the stud bolt 200. The plurality of engagement claws 104 are provided, for example, in pairs on opposite sides of the stud bolt 200 in the radial direction, and in two stages, one above and one below. A plurality of spring pieces 105 are provided on the surface of the fixing part 101 that opposes the mounting surface V2.

The fixing implement 100 is fixed to the vehicle body V1 by inserting the stud bolt 200 into the bolt compartment 102 of the fixing part 101 and engaging the stud bolt 200 with the engagement claws 104. At this time, in the fixing implement 100, the spring pieces 105 elastically contact the mounting surface V2, which enables the fixing part 101 to be favorably fixed to the mounting surface V2.

Actions of the present embodiment will be described next.

With the clamp 60, the holding implement 70 and the fixing implement 100 are formed as separate components, and the holding implement 70 and the fixing implement 100 are linked by linking the first linking part 90 of the holding implement 70 to the second linking part 110 of the fixing implement 100. The single clamp 60 is configured by linking the holding implement 70 and the fixing implement 100. Accordingly, for example, even if the structure of the fixing part 101 of the fixing implement 100 is changed to match the shape of the fixing target part, as long as the fixing implement 100 includes the second linking part 110, the fixing implement 100 can be linked to the holding implement 70 including the first linking part 90.

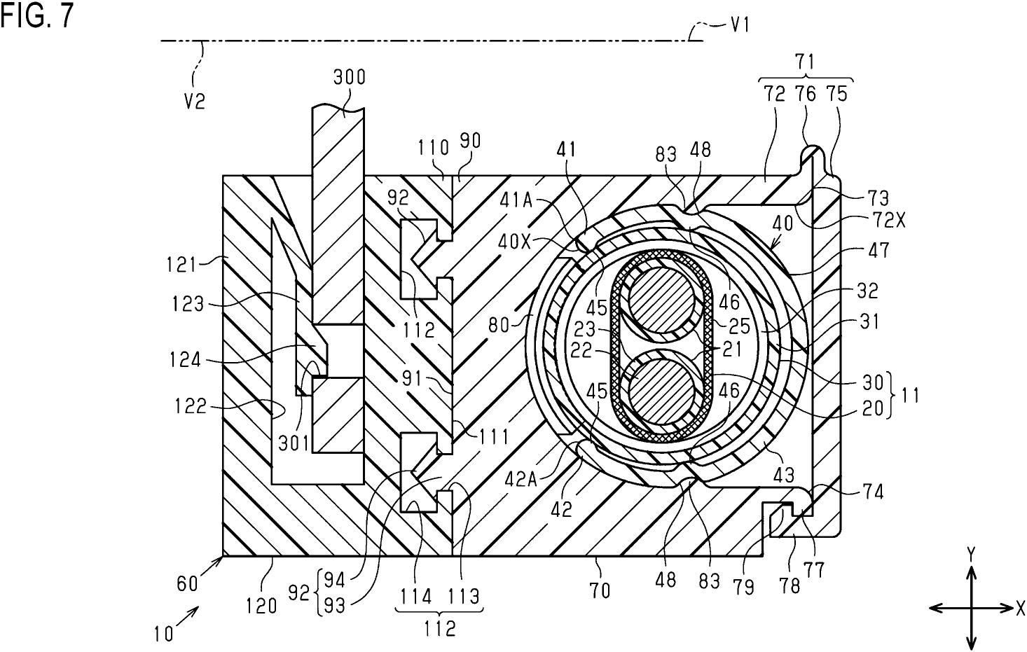

To be more specific, the clamp 60 of the present embodiment has a structure that includes the fixing implement 100, which is fixed to the vehicle body V1 by engaging with the stud bolt 200 protruding from the vehicle body V1, and the holding implement 70. In contrast, as illustrated in FIG. 7, as long as the second linking part 110 is provided, even a fixing implement 120 that is fixed to the vehicle body V1 by engaging with a plate-shaped attachment piece 300 can be linked to the holding implement 70 having the first linking part 90. The fixing implement 120 includes a fixing part 121 that engages with the attachment piece 300 and is fixed to the vehicle body V1, and the second linking part 110.

The fixing part 121 has an attachment piece compartment 122 into which the attachment piece 300 is inserted. The attachment piece compartment 122 opens toward the mounting surface V2 in the Y axis direction, for example. A locking arm 123 is provided inside the attachment piece compartment 122. The locking arm 123 is formed, for example, so as to extend diagonally downward, in FIG. 7, from the end on the mounting surface V2 side, in the Y axis direction. The tip of the locking arm 123 includes a locking projection 124 that protrudes into the attachment piece compartment 122. Here, the attachment piece 300 is provided, for example, on the vehicle body V1. The attachment piece 300 is, for example, a metal plate. The attachment piece 300 includes, for example, an attachment hole 301. The locking projection 124 of the locking arm 123 is fitted into the attachment hole 301. Specifically, upon being inserted into the attachment piece compartment 122, the attachment piece 300 advances through the attachment piece compartment 122, flexing and deforming by pressing on the locking arm 123. Then, when the attachment piece 300 is inserted until the attachment hole 301 is positioned opposite the locking projection 124, the locking arm 123 undergoes elastic restitution, and the locking projection 124 fits into the attachment hole 301. The locking projection 124 of the locking arm 123 therefore engages with the attachment hole 301 of the attachment piece 300. As a result, the fixing implement 120 is fixed to the vehicle body V1. The fixing implement 120 is then linked to the holding implement 70 by the second linking part 110.

In this manner, even if the structures of the fixing parts 101 and 121 are different, the fixing implement 100 or 120 having the second linking part 110 can be linked to the holding implement 70 having the first linking part 90. In other words, one type of holding implement 70 can be used in common for a plurality of types of fixing implements 100 and 120. Similarly, for example, a holding implement having a first linking part 90 similar to that of the holding implement 70 can be linked to the fixing implement 100 having the second linking part 110. In other words, one type of fixing implement 100 can be used in common for a plurality of types of holding implements 70.

Effects of the present embodiment will be described next.
(1) In the clamp 60, the holding implement 70 and the fixing implement 100 are formed as separate components, and the holding implement 70 and the fixing implement 100 are linked by linking the first linking part 90 and the second linking part 110. According to this configuration, one type of the holding implement 70 can be used in common for a plurality of types of fixing implements 100, and one type of fixing implement 100 can be used in common for a plurality of types of holding implements 70. This makes it possible to improve the versatility of the clamp 60.
   For example, even if the structure of the fixing target part to which the clamp 60 is fixed changes, it is not necessary to change the design of the entire clamp 60, and such a situation can be handled simply by changing the design of the fixing implement 100. This reduces the time required to redesign the clamp 60.
(2) The holding implement 70 and the fixing implement 100 are formed as separate components, and the holding implement 70 and the fixing implement 100 can therefore be manufactured separately. Accordingly, for example, the thickness of the holding implement 70 and the thickness of the fixing implement 100 can be set separately. Additionally, for example, the material of the holding implement 70 and the material of the fixing implement 100 can be set separately.
(3) The outer member 30 and the path restricting member 40 are held by the holding part 71 of the holding implement 70. The fixing implement 100 linked to the holding implement 70 is fixed to the vehicle body V1. Accordingly, the outer member 30 and the path restricting member 40 can be fixed to the vehicle body V1 by fixing the fixing implement 100 to the vehicle body V1.
(4) The insertion opening 40X of the path restricting member 40 opens in a direction orthogonal to the length direction of the first main body part 43, and extends over the entire length of the first main body part 43 in the length direction. Through this, the path restricting member 40 can be attached to the outer member 30 through the insertion opening 40X after performing terminal processing such as attaching the connectors C1 and C2 to the ends of the wire member 20 in the length direction. Accordingly, the path restricting member 40 can be retrofitted, which makes it possible to improve the ease of assembly of the wire harness 10.
(5) The holding part 71 includes the second main body part 72, and the lid part 75 linked to the second main body part 72. The holding part 71 is formed in an annular shape that surrounds the path restricting member 40 and the outer member 30 together. According to this configuration, the clamp 60 including the holding part 71 can be retrofitted to the path restricting member 40 and the outer member 30 by having the holding part 71 divided into the second main body part 72 and the lid part 75, even with the holding part 71 having an annular shape that surrounds the path restricting member 40 and the outer member 30. This further improves the ease of assembly of the wire harness 10.
(6) The holding part 71 includes the projecting part 80 that can contact at least one of the first end 41 and the second end 42 that form the insertion opening 40X in the circumferential direction of the path restricting member 40. Accordingly, the projecting part 80 is engaged with the first end 41 or the second end 42 in the circumferential direction of the path restricting member 40. These engagements suppress relative movement of the path restricting member 40 with respect to the holding part 71 in the circumferential direction of the path restricting member 40. In other words, a situation where the path restricting member 40 rotates in the circumferential direction relative to the holding part 71 can be suppressed by the projecting part 80 engaging with the first end 41 or the second end 42. Accordingly, misalignment of the path restricting member 40 with respect to the holding part 71 in the circumferential direction of the path restricting member 40 can be suppressed, and the positional accuracy of the path restricting member 40 with respect to the holding part 71 can be improved.
(7) The projecting part 80 includes the protrusion 81 that enters into the annular concave part 32 of the outer member 30, which makes it possible to suppress movement of the outer member 30 relative to the clamp 60 in the length direction of the outer member 30.
(8) The recess 48 provided in the outer surface of the first main body part 43 and the convex part 83 provided on the inner surface of the holding part 71 mate together, such that the recess 48 and the convex part 83 are engaged with each other in the circumferential direction of the path restricting member 40. This makes it possible to favorably suppress relative movement of the path restricting member 40 with respect to the holding part 71 in the circumferential direction of the path restricting member 40.

### Other Embodiments

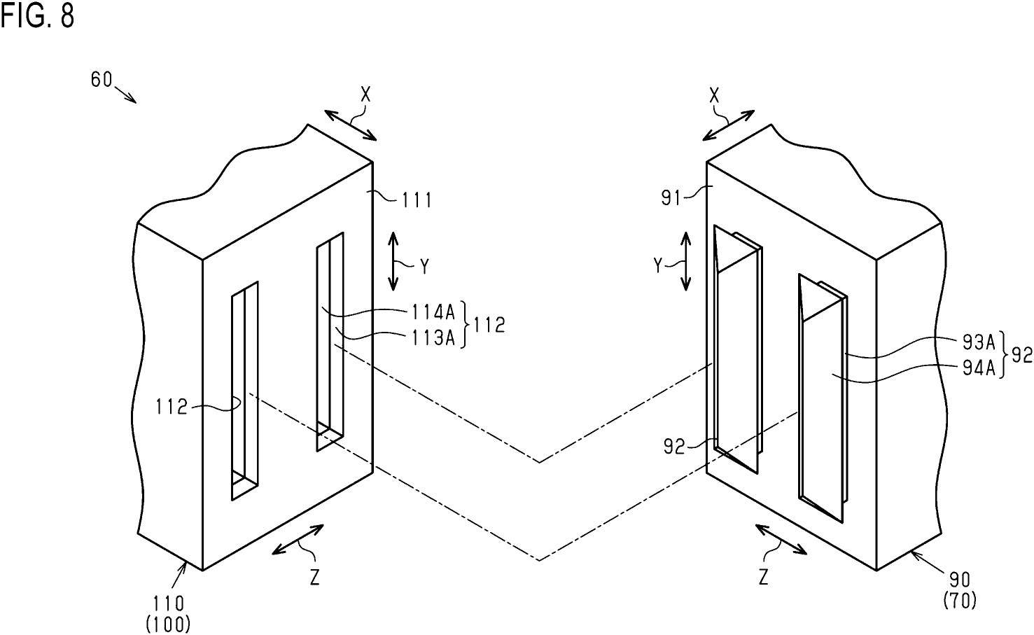

The above embodiment can be implemented with modifications such as those described hereinafter. The above embodiment and the following variations can be implemented in combination with each other to the extent that no technical conflicts arise.
In the above embodiment, the structures of the first linking part 90 and the second linking part 110 can be changed as appropriate. For example, the first linking part 90 and the second linking part 110 are not limited to any structure as long as those parts have structures that can be linked to each other.
The number of linking members 92 included in the first linking part 90 may be one, two, or three, or may be five or more. Similarly, the number of linking holes 112 included in the second linking part 110 may be one, two, or three, or may be five or more.
The positions where the linking members 92 and the linking holes 112 are formed may be changed as appropriate. For example, the linking members 92 may be provided in the center of the first opposing surface 91, and the linking holes 112 may be provided in the center of the second opposing surface 111.
The shape of each linking member 92 and each linking hole 112 may be changed as appropriate.
For example, as illustrated in FIG. 8, each linking member 92 may be changed to a shape that extends in one direction, which here is the Y axis direction. Each linking member 92 of the present variation extends in a straight line along the Y axis direction, for example. The first linking part 90 of the present variation includes two of the linking members 92. The two linking members 92 are provided side-by-side along the Z axis, which is orthogonal to both the Y axis and the X axis, for example. In the following descriptions, the direction extending along the Z axis will be referred to as the “Z axis direction”. Each linking member 92 of the present variation has, for example, a column part 93A formed in the shape of a square pillar, and an engagement piece 94A formed in the shape of a cone. The column part 93A extends in a straight line along the Y axis direction, for example. The engagement piece 94A is formed so as to protrude outward along the entire circumferential direction of the tip of the column part 93A, for example. The engagement piece 94A of the present variation is formed in the shape of a triangular pyramid. The second linking part 110 of the present variation includes two of the linking holes 112, each opposing a corresponding one of the two linking members 92. Each linking hole 112 in the present variation has a first opening 113A into which the column part 93A can be inserted and a second opening 114A capable of accommodating the engagement piece 94A.

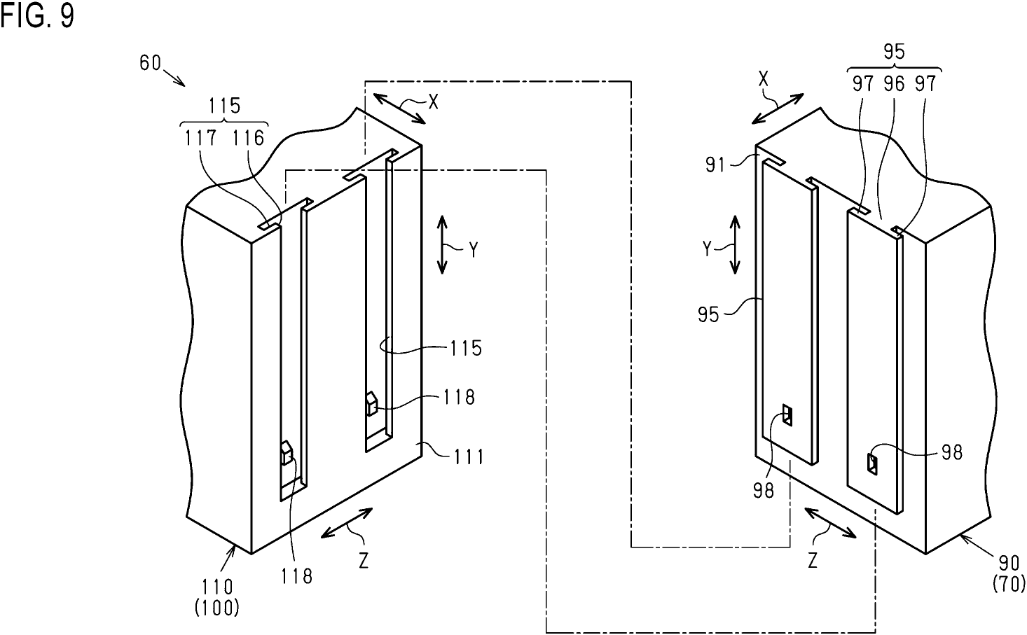

Each engagement piece 94A is formed so as to be capable of being inserted into and engaging with the linking hole 112. For example, the engagement piece 94A is formed so as to be capable of elastically deforming, to be capable of being inserted into the first opening 113A and capable of engaging with the outer edge of the first opening 113A after being inserted into the first opening 113A.
In the variation illustrated in FIG. 8, each linking member 92 and each linking hole 112 may be formed so as to extend in the Z axis direction.
In the above embodiment, the first linking part 90 includes the linking member 92, and the second linking part 110 includes a linking hole 112, but the configuration is not limited thereto. For example, the second linking part 110 may include the linking member 92 and the first linking part 90 may include the linking hole 112.
For example, as illustrated in FIG. 9, the structure may be changed to a structure that links the first linking part 90 to the second linking part 110 by sliding the first linking part 90 relative to the second linking part 110. The first linking part 90 of the present variation includes two linking members 95. The two linking members 95 are provided side-by-side in the Z axis direction, for example. Each linking member 95 extends in the Y axis direction.

Each linking member 95 includes a column part 96 and a pair of guide projections 97. The column part 96 protrudes from the first opposing surface 91 toward the second opposing surface 111. The column part 96 extends in a straight line along the Y axis direction, for example. The column part 96 of the present embodiment is formed in the shape of a square pillar. The pair of guide projections 97 protrude, for example, outward from both side surfaces of the column part 96, in the Z axis direction. The pair of guide projections 97 protrude, for example, in opposite directions in the Z axis direction. The pair of guide projections 97 protrude from both side surfaces at the tip of the column part 96. Each guide projection 97 extends in a straight line along the Y axis direction, for example. Each guide projection 97 extends over the entire length of the column part 96, for example, in the Y axis direction. The lateral cross-sectional shape of each linking member 95 is, for example, a T-shape. Each linking member 95 includes an engagement recess 98, for example. The engagement recess 98 is formed so as to be recessed from the protruding tip surface of the column part 96 toward the first opposing surface 91.

The second linking part 110 of the present variation includes two linking grooves 115. The two linking grooves 115 are provided side-by-side in the Z axis direction, for example. Each linking grooves 115 extends in the Y axis direction. Each linking groove 115 opens only in one direction in the Y axis direction, which here is the upward direction, for example. Each linking groove 115 includes a first groove 116 into which the column part 96 fits, and a pair of second grooves 117 into which the pair of guide projections 97 fit. The first groove 116 and the second grooves 117 communicate with each other. The first groove 116 is open toward the first linking part 90 in the X axis direction. The first groove 116 is formed to be concave along the X axis direction from the second opposing surface 111. The first groove 116 extends in a straight line along the Y axis direction, for example. The first groove 116 is formed at a size that enables the column part 96 to slide inside the first groove 116, for example. Each second groove 117 is formed, for example, so as to broaden with distance from the base surface of the first groove 116 in the Z axis direction. Each second groove 117 extends in a straight line along the Y axis direction. Each second groove 117 is not open toward the first linking part 90 in the X axis direction, for example. In other words, the second opposing surface 111 is interposed between each second groove 117 and the first linking part 90 in the X axis direction. Each second groove 117 is formed at a size that enables the guide projection 97 to slide inside the second groove 117, for example. Each linking groove 115 includes an engagement projection 118, for example. The engagement projection 118 protrudes from the base surface of the first groove 116 toward the first opposing surface 91. The engagement projection 118 is formed so as to be capable of engaging with the engagement recess 98.

In the present variation, each linking member 95 is inserted into a corresponding linking groove 115 from an opening above that linking groove 115. Specifically, the column part 96 is inserted into the first groove 116, and the guide projections 97 are inserted into the second grooves 117. Each linking member 95 is then slid downward inside of the corresponding linking groove 115. When the engagement projection 118 is fitted into the engagement recess 98, and the engagement projection 118 and the engagement recess 98 are engaged with each other, the first linking part 90 and the second linking part 110 are linked.
In the variation illustrated in FIG. 9, each linking member 95 and each linking groove 115 may be formed so as to extend in the Z axis direction.
In the variation illustrated in FIG. 9, the second linking part 110 may include the linking members 95, and the first linking part 90 may include the linking grooves 115.
In the above embodiment, the shapes, formation positions, and numbers of the recess 48 serving as the first engagement part and the convex part 83 serving as the second engagement part can be changed as appropriate.
In the above embodiment, the convex parts 83 are provided on the inner surface of the second main body part 72, but the configuration is not limited thereto, and the convex parts 83 may be provided on the inner surface of the lid part 75.
In the above embodiment, the recesses 48 are formed in the first main body part 43 and the convex parts 83 are formed in the second main body part 72, and the recesses 48 and the convex parts 83 are configured to mate together, but the concave and convex relationship may be reversed.
The recesses 48 may be provided partially in the length direction of the first main body part 43. For example, the recesses 48 may be provided only at the connection part 47 of the first main body part 43 in the length direction. Additionally, the recesses 48 may be provided partially in the length direction of the connection part 47. The recesses 48 may also be omitted.
The convex parts 83 may be provided partially in the length direction of the holding part 71. The convex parts 83 may also be omitted.
In the above embodiment, the protrusions 81 may be omitted from the projecting parts 80.
In the above embodiment, the projecting parts 80 are provided on the inner surface of the second main body part 72, by the configuration is not limited thereto, and the projecting parts 80 may be provided on the inner surface of the lid part 75. In this case, when the projecting part 80 provided on the inner surface of the lid part 75 is inserted into the insertion opening 40X of the path restricting member 40, for example, the position, in the circumferential direction, of the insertion opening 40X in the path restricting member 40 is set such that the holding part 71 faces toward the lid part 75.
In the above embodiment, the lateral cross-sectional shape of the inner surface of the second main body part 72 is not limited to a U-shape, and can be changed to a circular arc, an elliptical arc, or the like, for example.
In the above embodiment, the lateral cross-sectional shape of the inner surface of the lid part 75 is not limited to a straight line, and can be changed to a circular arc, an elliptical arc, or the like, for example.
In the holding part 71 of the above embodiment, the second main body part 72 and the lid part 75 are formed integrally with each other, but the configuration is not limited thereto, and the second main body part 72 and the lid part 75 may be separate. Even if the second main body part 72 and the lid part 75 are separate components, the lid part 75 is configured to be capable of being linked to the second main body part 72, and to be capable of surrounding and holding the path restricting member 40 together with the second main body part 72 when linked to the second main body part 72.

Although the holding part 71 includes the second main body part 72 and the lid part 75, and is configured to be capable of being retrofitted to the outer member 30, the configuration is not limited thereto. For example, the holding part 71 may be configured such that the lid part 75 is in a closed, immovable state. In this case, the clamp 60 cannot be retrofitted to the outer member 30 and, to be more specific, cannot be assembled from a direction orthogonal to the length direction of the outer member 30, which makes it necessary to assemble the clamp 60 through the outer member 30 in the length direction.
In the clamp 60, the direction in which the holding implement 70 and the fixing implement 100 are arranged is not limited. For example, the holding implement 70 and the fixing implement 100 may be provided side-by-side along the attachment direction in which the fixing implement 100 is attached to the vehicle body V1, i.e., along the Y axis direction.
In the above embodiment, two or more of the clamps 60 may be provided in the length direction of the path restricting member 40.
The fixing target part, to which the fixing implement 100 of the clamp 60 is fixed, is not particularly limited. The structure of the fixing part 101 can be modified as appropriate according to the structure of the fixing target part.
The held object to be held by the holding implement 70 of the clamp 60 is not particularly limited. The structure of the holding part 71 can be modified as appropriate according to the structure of the held object.
The structure of the path restricting member 40 in the above embodiment can be modified as appropriate. For example, the structure of the path restricting member 40 is not particularly limited to any structure as long as the first main body part 43 and the insertion opening 40X are provided, and the path restricting member 40 can be attached to the outer circumference of the outer member 30.
In the above embodiment, each second protrusion 46 is provided on the inner surface of the part of the first main body part 43 where the recess 48 is formed in the circumferential direction, but the configuration is not limited thereto. For example, the second protrusion 46 and the recess 48 may be provided in positions, in the circumferential direction of the first main body part 43, that are offset from each other.
Each second protrusion 46 may be partially provided in the length direction of the path restricting member 40.
At least one of the two second protrusions 46 may be omitted.
Each first protrusion 45 may be provided at a position further away from the insertion opening 40X than the tips 41A and 42A in the circumferential direction of the path restricting member 40.
Each first protrusion 45 may be partially provided in the length direction of the path restricting member 40.
At least one of the two first protrusions 45 may be omitted.
The path restricting member 40 is not limited to being provided under the floor of the vehicle V. The path restricting member 40 may be provided, for example, in the vehicle cabin of the vehicle V, as long as the path of the wire harness main body 11 extends in a straight line.
In the above embodiment, the path restricting member 40 is described as being stiffer than the outer member 30, but is not limited thereto, and may be as stiff as or less stiff than the outer member 30. In other words, the path restricting member 40 need not be stiffer than the outer member 30 as long as the path restricting member 40 functions to make the outer member 30 more difficult to bend than if the path restricting member 40 is not attached to the outer member 30.
At least one of the two restricting members 50 in the above embodiment may be omitted.
The path restricting member 40 may be omitted.
The outer member 30 may be, for example, a resin corrugated tube with a metal layer containing a metal material provided on the outer surface thereof.
The outer member 30 is not limited to a corrugated tube, and may be, for example, an outer member which does not include the annular convex parts 31 and the annular concave parts 32. The outer member 30 may be, for example, a metal pipe, a rigid plastic pipe, or the like.
The outer member 30 may have a slit extending in the length direction of the outer member 30.
Each of the wires 21 may be a low-voltage wire.
In the wire member 20, the electromagnetic shielding member is embodied as the braided member 25, but is not limited thereto, and for example, the electromagnetic shielding member may be embodied as a metal foil.
The braided member 25 in the wire member 20 may be omitted.
The number of wires 21 constituting the wire member 20 is described as being two, but is not limited thereto. The number of wires 21 may be one, three, or more.
The arrangement of the inverter M1 and the high-voltage battery M2 in the vehicle V is not limited to that described in the above embodiment, and may be modified as appropriate according to the vehicle configuration.
The plurality of vehicle-mounted devices that the wire harness 10 electrically connects are embodied as the inverter M1 and the high-voltage battery M2, but are not limited thereto. The plurality of vehicle-mounted devices to which the wire harness 10 electrically connects are not particularly limited, as long as they are electrical devices installed in the vehicle V.
Note that the embodiments disclosed above are to be understood as being in all ways exemplary and in no way limiting. The scope of the present disclosure is defined not by the above-described examples but by the scope of the claims, and all modifications equivalent in meaning and scope to the scope of the claims are intended to be included therein.

What is claimed is:

1. A clamp comprising:
a holding implement that holds an outer tube the outer tube being cylindrical and surrounding an outer circumference of a wire; and
a fixing implement that is linked to the holding implement and is fixed to a fixing target part, wherein:
the holding implement is a separate component from the fixing implement,
the holding implement includes a holding part that holds the outer tube, and a first linking part, and
the fixing implement includes a fixing part fixed to the fixing target part, and a second linking part linked to the first linking part.

2. A wire harness comprising:
a wire;
an outer tube that is cylindrical and that surrounds an outer circumference of the wire; and
a clamp attached to an outer circumference of the outer tube, wherein:
the clamp includes:
a holding implement that holds the outer tube; and
a fixing implement that is linked to the holding implement and is fixed to a fixing target part,
the holding implement is a separate component from the fixing implement,
the holding implement includes a holding part that holds the outer tube, and a first linking part, and
the fixing implement includes a fixing part fixed to the fixing target part, and a second linking part linked to the first linking part.

3. The wire harness according to claim 2, further comprising:
a path restricting cover that is attached to the outer circumference of the outer tube and that restricts a path along which the wire is routed, wherein:
the path restricting cover includes a first main body that covers part of the outer circumference of the outer tube, and an insertion opening that is open in a direction orthogonal to a length direction of the first main body and that extends over an entire length of the first main body in the length direction of the first main body, and
the holding part holds the outer tube and the path restricting cover.

4. The wire harness according to claim 3, wherein:
the holding part is formed in an annular shape that surrounds an outer circumference of the path restricting cover, and the outer circumference of a part of the outer tube to which the path restricting cover is attached, over an entire circumferential direction, and
the holding part includes a second main body, and a lid linked to the second main body.

5. The wire harness according to claim 4, wherein:
the path restricting cover includes a first engagement; and
the holding part includes a second engagement that engages with the first engagement in a circumferential direction of the path restricting cover.

6. The wire harness according to claim 5, wherein:
the path restricting cover includes a first end and a second end which are respective ends of the path restricting cover in the circumferential direction and which form the insertion opening,
the second engagement includes a projection that protrudes toward the insertion opening from an inner surface of the holding part, and
the projecdtion is capable of contacting at least one of the first end and the second end in the circumferential direction of the path restricting cover.

7. The wire harness according to claim 6, wherein:
the outer tube is a corrugated tube having an accordion structure in which an annular convex part and an annular concave part are provided alternately in series along a length direction of the outer tube, and
the projection enters into the annular concave part.

8. The wire harness according to claim 5, wherein:
the first engagement includes a recess provided in an outer surface of the first main body, and
the second engagement includes a convex part that protrudes toward the path restricting cover from the inner surface of the holding part and that mates with the recess.

9. The wire harness according to claim 8, wherein the path restricting cover includes:
a first end and a second end which are respective ends of the path restricting cover in the circumferential direction and which form the insertion opening;
a first protrusion that protrudes from an inner surface of at least one of the first end or the second end, and which is capable of contacting the outer surface of the outer tube; and
a second protrusion that protrudes from an inner surface of a part of the first main body where the recess is provided, and which is configured to contact the outer surface of the outer tube.
